(19) United States
(12) Patent Application Publication
(10) Pub. No.: US 2017/0352510 A1
(43) Pub. Date: Dec. 7, 2017

(54) THERMAL RESPONSE SWITCH

(71) Applicant: UBUKATA INDUSTRIES CO., LTD., Nagoya-shi, Aichi (JP)

(72) Inventor: Yoshio YAMAGUCHI, Nogoya-shi (JP)

(21) Appl. No.: 15/539,036

(22) PCT Filed: Dec. 24, 2014
(86) PCT No.: PCT/JP2014/084082

§ 371 Date: Jun. 22, 2017

(51) Int. Cl. H01H 37/54; F04B 39/00; F04C 29/00; H01H 37/14

(52) U.S. Cl. CPC H01H 37/5427; H01H 37/14; F04B 39/00; F04C 29/00

(57) ABSTRACT

A thermally responsive switch includes a heating element with a meandering portion formed of a metal plate. The meandering portion is bent twice with respect to reference axes extending in a longitudinal direction of a housing. The meandering portion includes an outer vertical portion that is perpendicular to an inner surface of a lid plate, an inner vertical portion that is perpendicular to the inner surface of the lid plate, and a middle vertical portion that is disposed between the outer vertical portion and the inner vertical portion and is perpendicular to the inner surface of the lid plate. The middle vertical portion has a narrow portion narrower than a width of the middle vertical portion. The narrow portion is provided on an end portion located in one side of the middle vertical portion where no other heating element exists among the two widthwise end portions of the middle vertical portion.

### CROSS-REFERENCE TO RELATED APPLICATIONS

This is a National Stage Entry into the United States Patent and Trademark Office from International PCT Patent Application No. PCT/JP2014/084082, having an international filing date of Dec. 24, 2014, the entire content of which is incorporated herein by reference.

### FIELD OF THE INVENTION

The present invention relates to a thermally responsive switch used as a protection device for motors or the like.

### BACKGROUND OF THE INVENTION

Many suggestions have been made for this type of thermally responsive switch which utilizes a thermally responsive element such as a bimetal. An example of such thermally responsive switch will be described with reference to FIGS. 10 and 11. A thermally responsive switch 101 is provided with a metal housing 102 and a lid plate 103. The lid plate 103 is fixed to an opening of the housing 102 by welding to form an airtight container. Through holes are formed through the lid plate 103. Metal conductive terminal pins 104A, 104B are inserted into the through holes. The conductive terminal pins 104A, 104B are airtightly fixed by an electrically insulating material 105 such as glass. A fixed contact 106 is fixed to a portion of one (conductive terminal pin 104A) of the conductive terminal pins located inside the airtight container. One end of a heater 107, being one example of a heating member, is connected to a portion of the other (conductive terminal pin 104B) of the conductive terminal pins located inside the airtight container. The other end of the heater 107 is connected to the lid plate 103.

A thermally responsive plate 109 configured by a bimetal or the like is connected to the inner side of the housing 102 via a connecting body 110. A movable contact 108 is provided on a movable end of the thermally responsive plate 109. The thermally responsive plate 109 is molded into a shallow dish shape. The thermally responsive plate 109 reverses its curving direction when it reaches a predetermined operating temperature and recovers its original curving direction when it reaches a predetermined recovering temperature. Normally, the movable contact 108 of the thermally responsive plate 109 is placed in contact with the fixed contact 106 as shown in FIG. 10.

The thermally responsive switch 101 is used for example in a sealed electric compressor that compresses refrigerant used in an air conditioner. In such case, the thermally responsive switch 101 is arranged inside a sealed housing of the compressor not shown, so that the conductive terminal pins 104A, 104B are series connected to a motor. During operation of the air conditioner, an operating current of the electric compressor flows through the thermally responsive switch 101 connected in the aforementioned manner, by the following route: the conductive terminal pin 104B—the heater 107—the lid plate 103—the housing 102—the connecting body 110—the thermally responsive plate 109—the movable contact 108—the fixed contact 106—the conductive terminal pin 104A. The current flowing in this manner causes the heater 107 and the thermally responsive plate 109 of the thermally responsive switch 101 to be heated. However, current flowing during normal operation of the air conditioner keeps the temperature of the thermally responsive plate 109 to be less than the operating temperature. Hence, the motor stays energized.

However, when the rotation of the motor is somehow restricted for example, an overcurrent which is several times larger than normal operation current flows through the motor. Thus, when left unattended, components such as motor coils may become burned.

When the heating value of the heater 107 and the thermally responsive plate 109 largely exceed the normal state due to overcurrent, the temperature of the thermally responsive plate 109 rises to the predetermined operating temperature and the curving direction of the thermally responsive plate 109 becomes reversed. As a result, the movable contact 108 fixed to the tip of the thermally responsive plate 109 is moved away from the fixed contact 106 to release the connection between the movable contact 108 and the fixed contact 106 and thereby cut off the electric circuit. The thermally responsive switch 101 releases the connection between the contacts in the above described manner when the compressor behaves abnormally to ensure that current is cut off from the motor before the motor coils reach a burning temperature.

Japanese Patent Publication No. 2005-240596 is representative of the prior art.

### SUMMARY OF THE INVENTION

For example, when the size of the electric compressor to be protected is small, its energization current is small. Thus, it is not possible for components such as the heater and the thermally responsive plate to be sufficiently self-heated under the structure of the conventional thermally responsive switch 101. Hence, measures need to be taken to increase the heating value of the heater and the thermally responsive plate. However, since limited types of metals are used as bimetal and tri-metal of the thermally responsive plate for example, resistivity can only be increased to a limited level. Hence, there is a limit to increasing the heating value by modifying the materials of the thermally responsive plate. Another conceivable approach for increasing the heating value is thinning the heat reactive plate to thereby reduce its cross-sectional area and increase the resistance value. However, since drive force for opening and closing the movable contact needs to be secured for the thermally responsive plate, there is also a limit to thinning the thermally responsive plate. Further, types of metal used as the material of the heater is also limited by the required physical properties such as weldability and by cost requirements. Hence, there is substantially a limit to replacing the material of the heater with a material having high resistivity. Thus, the most effective way to increase the heating value of the thermally responsive switch is to reduce the cross-sectional area of the heater while increasing the overall length of the heater.

Through creative efforts, the applicant has endeavored to reduce the cross-sectional area of the heater while extending its overall length. The applicant has conceived of the following configuration in the endeavor. According to the thermally responsive switch conceived by the applicant, a heating element of the heater is provided with multiple meandering portions formed of a strip-shaped metal plate. The multiple meandering portions are disposed so as to face one another with a conductive terminal pin disposed therebetween and a portion of the meandering portions are bent with respect to a predetermined reference axis.

According to the thermal responsive switch configured in the above described manner, it is possible to reduce the cross sectional area of the heater and further extend the overall length of the heater. As a result, it is possible to increase the heating value of the heater.

However, because the heater is provided with meandering portions and is bent within a small space inside the sealed container, there is a risk of a so-called heat bank being formed in the heater where straining is prone to occur and heat is prone to accumulate. Therefore, there is a concern that the heater may become fused at unexpected locations due to excessive heat generated by overcurrent. Thus, a technology is being conceived for controlling the location where fusing occurs due to excessive heat generated by overcurrent by intentionally providing a fusing portion to the heater which is easily fused compared to other portions of the heater. Such fusing portion is formed by providing a portion having a narrower width compared to other portions to the heater.

When such fusing portion is fused, droplets of melt known as sputter and formed of metal pieces and metal particles produced by the fusing are scattered. Current is discharged from the fusing portion to components such as the housing and the lid plate by the scattering of the sputter, thereby causing arc to continue. Thus, it may not be possible to completely cut off current flow even if the fusing portion is fused.

According to the thermally responsive switch of the present invention, a heating element of the heater has a meandering portion formed of a strip-shaped metal plate. The meandering portion is bent twice, namely with respect to a first reference axis and a second reference axis both extending in a longitudinal direction of a housing to thereby form an outer vertical portion located in an outer side of the first reference axis and being perpendicular to an inner surface of a lid plate, an inner vertical portion located in an inner side of the second reference axis and being perpendicular to the inner surface of the lid plate, and an middle vertical portion located between the first reference axis and the second reference axis so as to be disposed between the outer vertical portion and the inner vertical portion and being perpendicular to the inner surface of the lid plate. The middle vertical portion has a narrow portion narrower than a width of said middle vertical portion. The narrow portion is provided on an end portion located in one side of the middle vertical portion where no other heating element exists among two widthwise end portions of the middle vertical portion.

According to the thermally responsive switch of the present invention, the narrow portion serving as a fusing portion is provided on the end portion located in one side of the middle vertical portion where no other heating element exists among the two widthwise end portions of the middle vertical portion. According to such configuration, the sputter generated when the narrow portion is fused scatters toward a relatively wide space where no other heating elements of the heater exists. Thus, even if arc is generated by the sputtering, it is possible to extinguish the arc before it is transferred to other portions and thereby allowing current flow to be cut off.

### BRIEF DESCRIPTION OF THE DRAWINGS

FIG. 1 is a front view of a thermally responsive switch of one embodiment.

FIG. 2 is a vertical cross-sectional view of the thermally responsive switch.

FIG. 3 is a transverse cross-sectional view of the thermally responsive switch.

FIG. 4 is a perspective view of a heater.

FIG. 5 is a development of the heater.

FIG. 6 is a plan view of the heater.

FIG. 7 is a perspective view of a main portion of the heater.

FIG. 8 is an enlarged view of a narrow portion located at a middle vertical portion and its periphery.

FIG. 9A is a vertical cross-sectional side view of the heater taken along line A-A of FIG. 6.

FIG. 9B is a vertical cross-sectional side view of the heater taken along line B-B of FIG. 6.

FIG. 9C is a vertical cross-sectional side view of the heater taken along line C-C of FIG. 6.

FIG. 9D is a side view of the heater.

FIG. 10 is a vertical cross-sectional view of a conventional thermally responsive switch.

FIG. 11 is a transverse cross-sectional view of a conventional thermally responsive switch.

### DESCRIPTION OF EMBODIMENT(S) OF THE INVENTION

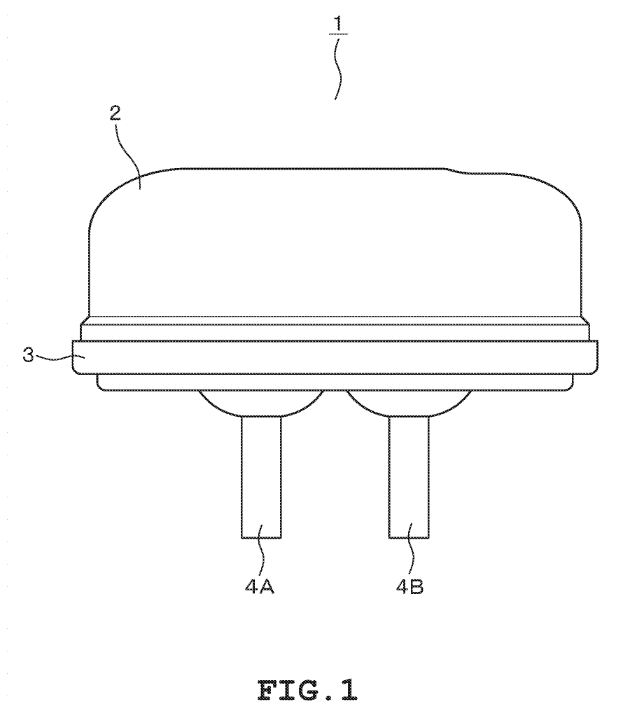

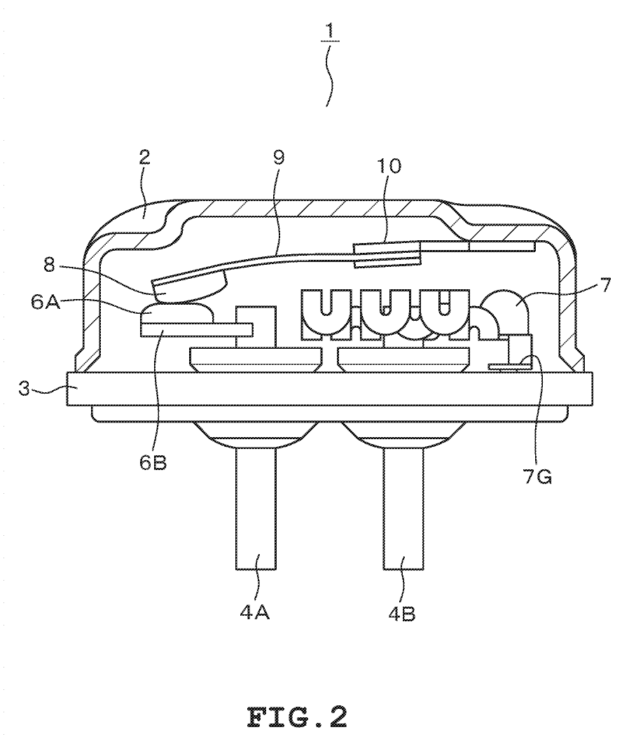

A description will be given hereinafter on one embodiment of a thermally responsive switch to which the present invention is applied with reference to the drawings. As shown in FIGS. 1 and 2, a thermally responsive switch 1 is an airtight container configured of a metal housing 2 and a lid plate 3. The housing 2 is formed into a long-dome shape having an open end. The lid plate 3 is airtightly fixed to the open end of the housing 2 by welding or the like. Conductive terminal pins 4A, 4B made of metal are inserted into two through holes provided in the lid plate 3. These conductive terminal pins 4A, 4B are fixed by an electrically insulating filler such as glass. Thus, the conductive terminal pins 4A, 4B are airtightly fixed in an electrically insulated state.

A fixed contact 6A is fixed, through a conductive fixed contact support 6B, to a portion of the conductive terminal pin 4A located inside the airtight container. Also, a thermally responsive plate 9 configured of bimetal or tri-metal, for example, is fixed to the inner side of the housing 2 through a connecting body 10. The thermally responsive plate 9 is formed into a dish shape by drawing and has one end connected to an inner surface of the housing 2 through the connecting body 10. The thermally responsive plate 9 reverses its curving direction when it reaches a predetermined temperature. Also, a movable contact 8 is fixed to a movable end which is the other end of the thermally responsive plate 9.

When the thermally responsive plate 9 is reversed, the movable contact 8 moves away from the fixed contact 6A. This releases the connection between the movable contact 8 and the fixed contact 6A, and cuts off an electric circuit formed of: the conductive terminal pin 4B—a heater 7—the lid plate 3—the housing 2—the connecting body 10—the thermally responsive plate 9—the movable contact 8—the fixed contact 6A—the fixed contact support 6B—the conductive terminal pin 4A. Note that in a normal state in which the thermally responsive plate 9 is not reversed, the movable contact 8 is placed in contact with the fixed contact 6A and forms the above electric circuit. Thus, the movable contact 8 opens and closes the electric circuit by being driven by the thermally responsive plate 9 to come into contact with and separate from the fixed contact 6A.

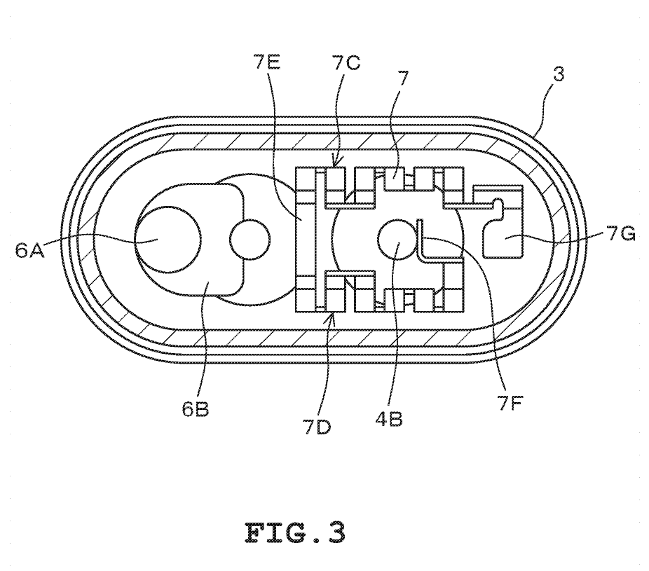

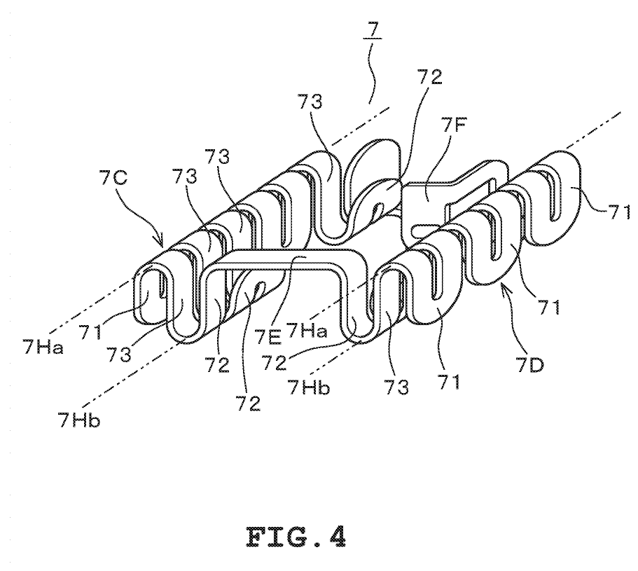

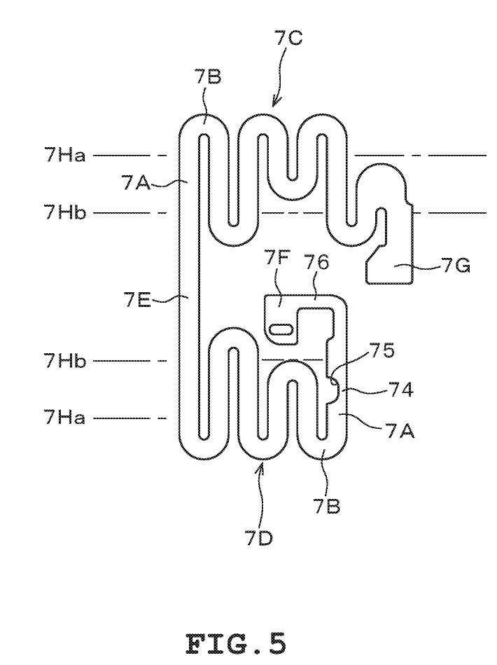

As also shown in FIG. 3, one end of the heater 7 is connected to a portion of the conductive terminal pin 4B located inside the airtight container. The other end of the heater 7 is connected to an inner surface of the lid plate 3. The shape of the heater 7 will be described with reference to FIGS. 4 and 5. The heater 7, taking a three-dimensionally meandering shape as shown in FIG. 4, is manufactured by bending a strip-shaped heater forming material meandering as illustrated in FIG. 5 with respect to predetermined references axes 7Ha and 7Hb serving as folding lines. The heater forming material shown in FIG. 5 is obtained, for example, by blanking a planar metal plate having a predetermined resistivity. The heater 7 has meandering portions, and the meandering portions are bent. That is, the heater 7 is configured of multiple heater units including a linear portion 7A being a linear heating element and a semicircular portion 7B being a semicircular heating element. Multiple heater units are alternately connected by joining the linear portion 7A of one heater unit to the semicircular portion 7B of another heater unit to form the heater 7. Thus, the heater 7 has multiple meandering portions 7C, 7D in which multiple linear portions 7A are provided adjacent to one another with the semicircular portion 7B interposed therebetween.

The structure of the heater 7 adopts the meandering heating element so that a longer electric circuit can be obtained in a limited space. The meandering portions 7C, 7D are connected by a connecting portion 7E. In this case, the connecting portion 7E is a strip-shaped element extending in a straight line. However, the connection portion 7E may be configured as a meandering portion. Further, fixing portions 7F, 7G are provided on the two end portions of the heater 7.

The meandering portions 7C, 7D are bent twice with respect to a predetermined first reference axis 7Ha and a second reference axis 7Hb illustrated in FIG. 5. The first reference axis 7Ha and the second reference axis 7Hb are each an axis extending along a longitudinal direction of the housing 2 shaped like a long dome. Further, the first reference axis 7Ha is set so as to be located on the outer side of the second reference axis 7Hb as viewed in the width direction of the heater 7 and the second reference axis 7Hb is set so as to be located on the inner side of the first reference axis 7Ha as viewed in the width direction of the heater 7. More specifically, the second reference axis 7Hb is set on the outer sides of the two ends of the connecting portion 7E so as to sandwich the connecting portion 7E and the first reference axis 7Ha is set further on the outer side of the second reference axis 7Hb.

The first reference axis 7Ha and the second reference axis 7Hb extend in a direction perpendicular to the direction in which the linear portion 7A extends and the direction in which the connecting portion 7E connecting the meandering portions 7C, 7D extends. In the meandering portion 7D, the linear portion 7A of the heater unit located in the portion facing the fixing portion 7F (the portion facing the conductive terminal pin 4B when mounted inside the airtight container) is shorter than the linear portions 7A of other heater units 7A. In the meandering portion 7C, the linear portion 7A of the heater unit located in the portion facing the fixing portion 7F (the portion facing the conductive terminal pin 4B when mounted inside the airtight container) is shorter than the linear portions 7A of other heater units 7A.

The meandering portions 7C, 7D are bent with respect to the first reference axis 7Ha and the second reference axis 7Hb such that a first surface of the two surfaces of the linear portion 7A faces the same first surface. In other words, the meandering portions 7C, 7D are bent 180 degrees at two locations, namely with respect to the first reference axis 7Ha and with respect to the second reference axis 7Hb. In the meandering portions 7C, 7D bent in this manner, a predetermined gap is formed between opposing planes of the first surface of the same linear portion 7A, that is, between the surfaces located on the inner side in the bent state. Further, the meandering portions 7C, 7D are configured such that the strip-shaped planar portions constituting the linear portions 7A face each other. Also, the meandering portions 7C, 7D are bent such that the linear portions 7A extend in the direction perpendicular to the connecting portion 7E. The heater 7 is arranged inside the airtight container such that the connecting portion 7E is parallel to the inner surface of the lid plate 3. Accordingly, the heater 7 is arranged inside the airtight container such that the linear portions 7A extend in a direction perpendicular to the inner surface of the lid plate 3.

By bending the meandering portions 7C, 7D in this manner, it is possible to reduce the dimension of the heater 7 in the width direction which is the direction perpendicular to the first reference axis 7Ha and the second reference axis 7Hb and which is the extending direction of the connection portion 7E. Hence, the heater 7 can be accommodated in a smaller space and the heater 7 having a longer overall length can be arranged inside a conventional-sized airtight container. Also, the heater 7 having the meandering portions 7C, 7D bent in this manner is arranged inside the airtight container such that the linear portion 7A of one meandering portion 7C faces the linear portion 7A of the other meandering portion 7D. Additionally, the heater 7 is arranged inside the airtight container such that the linear portion 7A of one meandering portion 7C is parallel to the linear portion 7A of the other meandering portion 7D.

Also, when arranged inside the airtight container, the heater 7 surrounds the periphery of the conductive terminal pin 4B with the fixing portion 7G—the meandering portion 7C—the connecting portion 7E—the meandering portion 7D—the fixing portion 7F. That is, the heater 7 is arranged around the conductive terminal pin 4B so as to form a spiral. Further, the heater 7 is arranged so that the meandering portions 7C, 7D oppose each other with the conductive terminal pin 4B interposed therebetween. Also, the heater 7 is arranged such that the meandering portions 7C, 7D are parallel to the inner surface of the lid plate 3. The heater 7 is also arranged such that the side surfaces on the outer sides of the meandering portions 7C, 7D are aligned with an inner peripheral surface of the housing 2. The fixing portion 7G being an end portion of the heater 7 on the circumferential edge side is fixed to the inner surface of the lid plate 3 by welding, for example. On the other hand, the fixing portion 7F being an end portion of the heater 7 on the center side is fixed to an end portion of the conductive terminal pin 4B inside the airtight container by welding, for example.

Further, the heater 7 is arranged inside the airtight container such that the connection portion 7E is on the thermally responsive plate 9 side, a bent portion closest to the connection portion 7E is on the lid plate 3 side, and the next bent portion is on the thermally responsive plate 9 side. Hence, when the heater 7 is arranged inside the airtight container, its area is larger on the thermally responsive plate 9 side than on the lid plate 3 side which is opposite of the thermally responsive plate 9 side.

Further creative efforts are put in to the shape of the heater 7 which will be described hereinafter. As shown in FIG. 4, the meandering portions 7C, 7D are bent twice with respect to the first reference axis 7Ha and the second reference axis 7Hb extending in the longitudinal direction of the housing 2 so that each of the meandering portions 7C, 7D form multiple outer vertical portions 71, multiple inner vertical portions 72, and multiple middle vertical portions 73. The outer vertical portion 71 is located in the outer side of the first reference axis 7Ha and is vertical with respect to the inner surface of the lid plate 3. The inner vertical portion 72 is located in the inner side of the second reference axis 7Hb and is vertical with respect to the inner surface of the lid plate 3. The middle vertical portion 73 is located between the first reference axis 7Ha and the second reference axis 7Hb so as to be interposed between the outer vertical portion 71 and the inner vertical portion 72 and is vertical with respect to the inner surface of the lid plate 3.

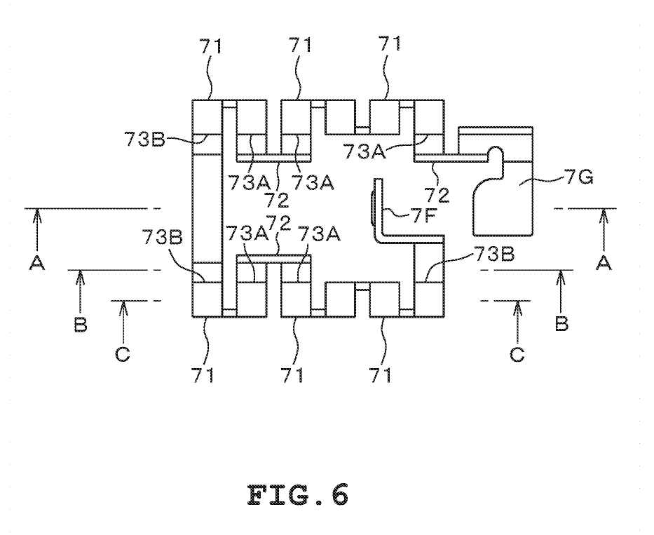

The middle vertical portions 73 formed in the heater 7 can be categorized into two types, namely, type A in which other middle vertical portion 73 exists on both widthwise end portions of the middle vertical portion 73 and type B in which other middle vertical portion 73 does not exist on one of the widthwise end portions of the middle vertical portion 73 as shown in FIG. 6. In this example, three type B middle vertical portions 73B are formed in a single heater 7; that is, one middle vertical portion 73B formed in immediate proximity of the fixing portion 7F and two middle vertical portions 73B formed on both ends of the connecting portion 7E. In the thermally responsive switch 1 of the present embodiment, special creative efforts are put in to the shape of the middle vertical portion 73B formed in immediate proximity of the fixing portion 7F.

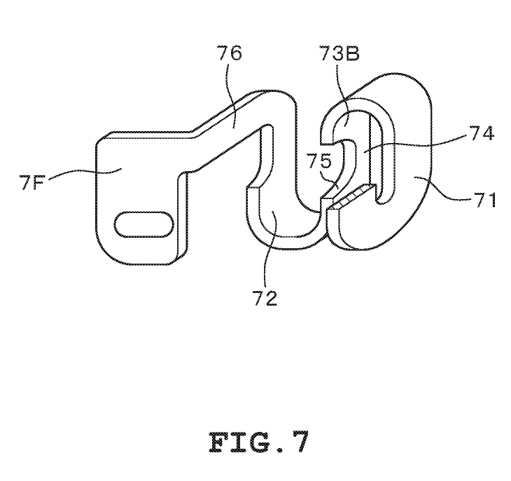

FIG. 7 illustrates a part of the heater 7 and in particular, the part near the fixing portion 7F. A narrow portion 74, serving as a fuse portion that melts more easily compared to other portions of the heater 7, is formed to the middle vertical portion 73B formed in immediate proximity of the fixing portion 7F. The narrow portion 74 is located at one of the two widthwise end portions of the middle vertical portion 73B in which other heating element does not exist and has a narrower width compared to the middle vertical portion 73B. As shown in FIG. 3, the thermally responsive switch 1 is arranged inside the airtight container so that relatively wide space is secured in the side of the end portion where the narrow portion 74 is provided among the two end portions of the middle vertical portion 73B.

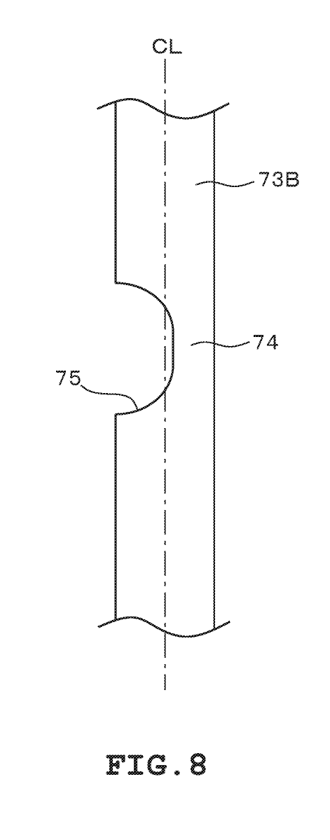

As also shown in FIG. 8, the narrow portion 74 is provided so as to be shifted toward the end portion located in the free side of the middle vertical portion 73B where no other heating element exists (the end portion in the right side as viewed in FIG. 8) as viewed in the width direction of the middle vertical portion 73B. That is, the narrow portion 74 is provided in a position shifted toward the free side of the middle vertical portion 73B relative to a center line CL as viewed in the width direction of the middle vertical portion 73B. On the end portion of the middle vertical portion 73B located in the opposite side of the narrow portion 74, that is, on the end portion located in the side where other heating element exists, a recess 75 is formed which caves in the shape of a circular arc toward the end portion located in the side where no other heating element exists. The shape of the recess 75 is not limited to a circular arc.

Further, the heater 7 is provided with a thin portion 76 between the fixing portion 7F which is an end portion connected to the conductive terminal pin 4B and the inner vertical portion 72 which faces the middle vertical portion 73B provided with the narrow portion 74. The width of the thin portion 76 is at least thinner than the width of the inner vertical portion 72. Thus, the heater 7, when starting from the fixing portion 7F becomes temporarily thin at the thin portion 76 and thereafter is widened at the inner vertical portion 72. Then, the narrow portion 74 is provided at the middle vertical portion 73B which comes after the inner vertical portion 72.

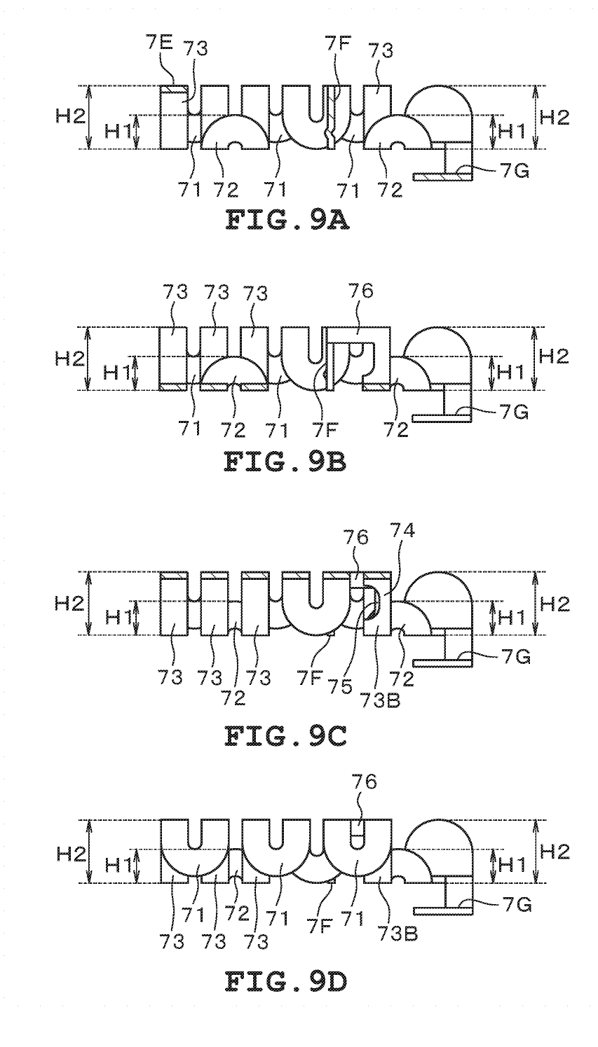

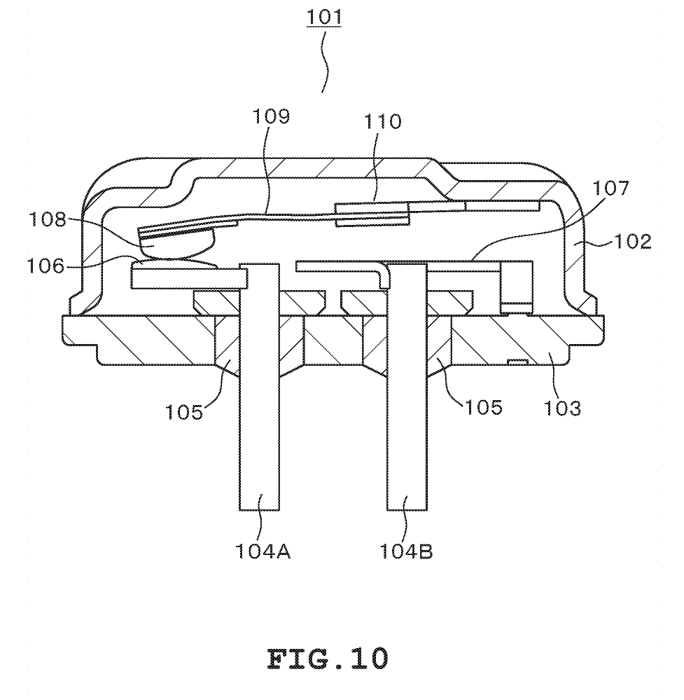

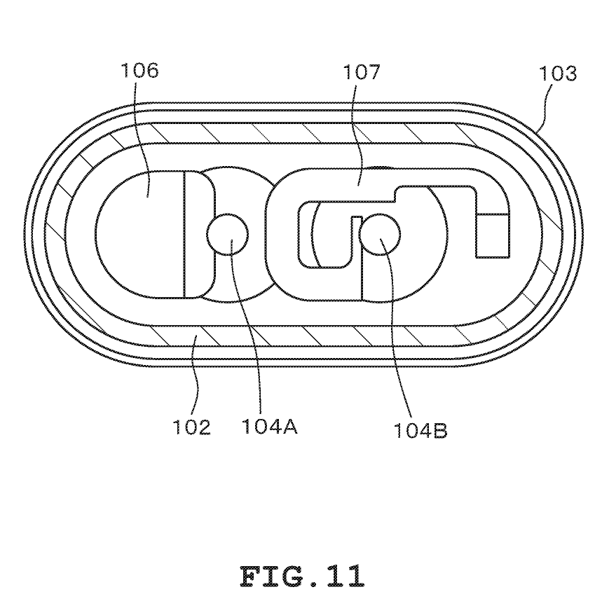

Further, as illustrated in FIGS. 9A to 9D, a vertical dimension H1 of the inner vertical portion 72 is shorter than a vertical dimension H2 of the middle vertical portion 73. Though not shown, the heater 7 may be configured so that the vertical dimension of the outer vertical portion 71 is shorter than the vertical dimension of the middle vertical portion 73 or the vertical dimensions of both the outer vertical portion 71 and the inner vertical portion 72 are shorter than the vertical dimension of the middle vertical portion 73. In other words, the heater 7 may be configured so that at least either of the outer vertical portion 71 and the inner vertical portion 72 is shorter than the middle vertical portion 73.

According to the thermally responsive switch 1 of the present embodiment, the heating elements of the heater 7 are provided with meandering portions 7C, 7D formed of a strip-shaped metal plate. Each of the meandering portions 7C, 7D is bent twice with respect to the first reference axis 7Ha and the second reference axis 7Hb extending in the longitudinal direction of the housing 2. As a result, the meandering portions 7C, 7D are each provided with the outer vertical portion 71 disposed in the outer side of the first reference axis 7Ha so as to be perpendicular to the inner surface of the lid 3, the inner vertical portion 72 disposed in the inner side of the second reference axis 7Hb so as to be perpendicular to the inner surface of the lid 3, and the middle vertical portion 73 disposed between the first reference axis 7Ha and the second reference axis 7Hb and between the outer vertical portion 71 and the inner vertical portion 72 so as to be perpendicular to the inner surface of the lid 3. Among the multiple middle vertical portions 73, the middle vertical portion 73B provided in immediate proximity of the fixing portion 7F is provided with the narrow portion 74 being narrower than the width of the middle vertical portion 73B on the end portion located in the free side of the middle vertical portion 73B where no other heating element exists among the two widthwise end portions of the middle vertical portion 73B.

According to the thermally responsive switch 1, the narrow portion 74 serving as the fusing portion is provided on the end portion located in the free side of the middle vertical portion 73B where no other heating element exists among the two widthwise end portions of the middle vertical portion 73B. Relatively wide space is provided beside the end portion in the free side of the middle vertical portion 73B. According to such configuration, the sputter generated when the narrow portion 74 is fused scatters toward the relatively wide space where no other heating elements of the heater 7 exists. Thus, even if arc is generated by the sputtering, it is possible to extinguish the arc before it is transferred to other portions such as the housing 2 and the lid 3 and thereby allowing current flow to be cut off.

As illustrated in FIG. 6, the heater 7 is provided with three type-B middle vertical portions 73B in which no other middle vertical portion 73 exists on one of the two widthwise end portions of the middle vertical portion 73. Among them, the two middle vertical portions 73B other than the middle vertical portion 73B located in immediate proximity of the fixing portion 7F are disposed near the thermally responsive plate 9. Thus, when the narrow portion 74 having a relatively large heating value is formed at these two middle vertical portions 73B, heat transfer may occur in a concentrated manner between the heater 7 and the thermally responsive plate 9 and possibly affect the stability of operation. In the thermally responsive switch 1 according to the present embodiment, the narrow portion 74 is formed at the middle vertical portion 73B located most distant from the thermally responsive plate 9. It is thus, possible to prevent the operation of the switch from becoming unstable by the formation of the narrow portion 74.

Further according to the thermally responsive switch 1, the heater 7 forms meandering portions 7C, 7D configured of meandering strip-shaped metal plates. The meandering portions 7C, 7D are bent twice with respect to two reference axes 7Ha and 7Hb to provide a complicated shape. According to such structure, heat tends to accumulate especially in the middle vertical portion 73 disposed between the outer vertical portion 71 and the inner vertical portion 72. According to the thermally responsive switch 1, the heater 7 is configured so that the vertical dimension of the inner vertical portion 72 is shorter than the vertical dimension of the middle vertical portion 73. It is thus, possible to reduce the area of the inner vertical portion 72 facing the middle vertical portion 73. In other words, it is possible to increase the area of the middle vertical portion 73 for releasing heat. As a result, it is possible to improve heat dissipation from the middle vertical portion 73 and prevent excessive temperature elevation at the middle vertical portion 73 to thereby provide a homogenous temperature distribution.

Further according to the thermally responsive switch 1, the heater 7 is configured so that thin portion 76 thinner than the inner vertical portion 72 is provided between the fixing portion 7F connected to the conductive terminal pin 4B and the inner vertical portion 72. According to such configuration, it is possible to prevent the temperature of the inner vertical portion 72 from becoming too low by the heat escaping towards the conductive terminal pin 4B side from the fixing portion 7F. The heater 7 is required to generate amount of heat which is correlated with the size of current flowing through the heater 7. When heat escapes towards the conductive terminal pin 4B side from the fixing portion 7F, the temperature of the inner vertical portion 72 may become too low. Especially because the narrow portion 74 exhibiting relatively large heating value is located close to the fixing portion 7F in the present embodiment, it may not be possible to obtain the desired fusing performance when subjected to overcurrent. Thus, according to the thermally responsive switch 1 of the present embodiment, the thin portion 76 is provided to increase the heating value in the vicinity of the fixing portion 7F. As a result, heat at the inner vertical portion 72 including the narrow portion 74 does not easily escape toward the conductive terminal pin 4B side. It is thus, possible to maintain the capacity of the heater 7 to generate amount of heat which is correlated with the size of current flowing through the heater 7.

The present invention is not limited to the embodiment described above but may be modified or expanded within the gist of the invention. For example, the number of meandering portions provided to the heater is not limited to two but may be increased or decreased as required.

1. A thermally responsive switch comprising:
an airtight container comprising a lid plate airtightly secured to an open end of a metal housing formed into a long-dome shape;
two conductive terminal pins each inserted into each of two through holes provided in the lid plate, the conductive terminal pins being airtightly fixed by an electrically insulating filler;
a fixed contact fixed to one of the two conductive terminal pins inside the airtight container;
a heater having one end connected to the other of the two conductive terminal pins and the other end connected to the lid plate inside the airtight container;
a thermally responsive plate having one end connected to an inner surface of the housing, a curving direction of the thermally responsive plate being reversed at a predetermined temperature; and
a movable contact provided on the other end of the thermally responsive plate and constituting a pair of switching contacts with the fixed contact,
wherein a heating element of the heater has a meandering portion formed of a strip-shaped metal plate, the meandering portion being bent twice, namely with respect to a first reference axis and a second reference axis both extending in a longitudinal direction of the housing to thereby form an outer vertical portion located in an outer side of the first reference axis and being perpendicular to an inner surface of the lid plate, an inner vertical portion located in an inner side of the second reference axis and being perpendicular to the inner surface of the lid plate, and an middle vertical portion located between the first reference axis and the second reference axis so as to be disposed between the outer vertical portion and the inner vertical portion and being perpendicular to the inner surface of the lid plate, and
wherein the middle vertical portion has a narrow portion narrower than a width of said middle vertical portion, the narrow portion being provided on an end portion located in one side of the middle vertical portion where no other heating element exists among two widthwise end portions of the middle vertical portion.

2. The thermally responsive switch according to claim 1, wherein at least one of the outer vertical portion and the inner vertical portion is shorter than the middle vertical portion.

3. The thermally responsive switch according to claim 1, wherein the heater includes a thin portion thinner than the inner vertical portion, the thin portion being disposed between the one end of the heater connected to the conductive terminal pin and the inner vertical portion.

4. The thermally responsive switch according to claim 1, wherein plural middle vertical portions are provided, and among the plural middle vertical portions, the narrow portion is provided in a middle vertical portion formed in immediate proximity of the one end of the heater connected to the conductive terminal pin.

5. The thermally responsive switch according to claim 2, wherein the heater includes a thin portion thinner than the inner vertical portion, the thin portion being disposed between the one end of the heater connected to the conductive terminal pin and the inner vertical portion.

6. The thermally responsive switch according to claim 2, wherein plural middle vertical portions are provided, and among the plural middle vertical portions, the narrow portion is provided in a middle vertical portion formed in immediate proximity of the one end of the heater connected to the conductive terminal pin.

7. The thermally responsive switch according to claim 3, wherein plural middle vertical portions are provided, and among the plural middle vertical portions, the narrow portion is provided in a middle vertical portion formed in immediate proximity of the one end of the heater connected to the conductive terminal pin.
